(19) United States
(12) Patent Application Publication
(10) Pub. No.: US 2003/0025682 A1
(43) Pub. Date: Feb. 6, 2003

(54) Aural/visual checklist system for avionics

(76) Inventor: Stephen G. Dame, Everett, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 10/190,446

(22) Filed: Jul. 5, 2002

Related U.S. Application Data
(60) Provisional application No. 60/303,365, filed on Jul. 6, 2001.

(51) Int. Cl. G09G 5/00

(52) U.S. Cl. 345/184

(57) ABSTRACT

An improved aural/visual checklist system is presented. One embodiment of the system comprises a processor which controls the operation of the checklist system and memory connected to the processor. The memory stores alphanumeric data arranged in a set of predetermined checklists, each of which has a set of predetermined tasks and audio files associated with each predetermined task within each set of predetermined tasks. The system further comprises a display connected to the memory which displays the alphanumeric data stored in the memory. Other embodiments of the system further comprise an input device connected to the processor which enables an operator of the checklist system to scroll backward or forward though each set of predetermined tasks within each set of predetermined checklists and an audio output circuit connected to the processor which plays an audio file associated with a predetermined task within a set of predetermined tasks, the audio file playing when the associated predetermined task is displayed on the display means.

### CROSS-REFERENCE TO RELATED APPLICATIONS

This application claims priority from commonly owned U.S. Provisional Patent Application 60/303,365, titled IMPROVED AURAL/VISUAL CHECKLIST FOR AVIONICS, presently pending, which is hereby incorporated by reference in its entirety.

### FIELD OF THE INVENTION

The present invention pertains generally to avionics communications equipment, and more particularly to a device for providing interactive aural and visual checklist information to pilots.

### BACKGROUND OF THE INVENTION

Procedural checklists are a required set of materials that accompany the practice of both professional and recreational piloting of aircraft vehicles. They provide the means to accurately jog human memory of both highly trained pilots, and pilots who are only minimally able to maintain their skills through infrequent refresher flights. Checklists provide the foundation for safely operating these precise and complex vehicles under normal operating conditions as well as emergency and/or abnormal conditions.

A pilot's attention is continuously divided among many different tasks at different times while acting as Pilot in Command of an aircraft. Many of these tasks are time critical and prompt attention to a series of tasks is always a requirement. For Visual Flight Rules (VFR) flights it is a requirement that the pilot divide his attention such that a majority of his time is spent looking outside the aircraft and the rest is devoted to instrument and systems indicator scanning. Under Instrument Flight Rules (IFR) a majority of pilot's time is spent scanning his instruments for correct situational awareness and constant monitoring of onboard systems. In addition, much voice communication is required at different phases of flight and constant tuning of radios and navigational instruments also competes for a pilot's attention and adds to his cockpit workload.

In the past, checklist systems have been developed to aid a pilot with the cockpit workload. One such system is disclosed by U.S. Pat. No. 4,970,683 to Harshaw et al. which is incorporated by reference herein. Harshaw et al. discloses an aural checklist management system that includes aural annunciation of the checklist items on a checklist. However, the Harshaw et. al. device suffers from several disadvantages.

First, the user navigational logic is confusing due to the limited user interface controls and presentation method whereby only one sub-list title or checklist item can be displayed and announced at any point in time. Additionally, the Harshaw et al. device utilizes only one set of pushbuttons to provide all of the navigation and operation of the automated checklist. Harshaw et al. define three switch means to provide this navigation: 1) an “action complete signal” or a GO pushbutton as described in the preferred embodiment, 2) a “skip signal” or SKIP button as described in the preferred embodiment, and 3) an “exit signal” or EXIT button as described in the preferred embodiment. All three of these signals are used for both the navigation of checklist sub-list titles as well as checklist items themselves. This provides a somewhat suitable interface for processing the checklist items (with the limitation of only one checklist item displayed at a time), but when browsing through sub-list titles or sub-lists of sub-lists, these GO and SKIP user interface controls lose their contextual meaning.

Next, if the user of the Harshaw et al. device presses the EXIT button when processing a checklist, the system automatically takes him back to the sub-list title of the previous checklist. If the user accidentally presses this same button again then he is up two levels and then has to navigate back down into the sub-list titles and then press GO or SKIP to find his way back to the checklist he was processing.

Finally, the lack of any other cursor or scrolling user interface element forces the user to overlap using of the GO, SKIP and EXIT buttons to provide awkward navigation of checklist titles and checklist items.

### SUMMARY OF THE INVENTION

The present invention is directed to a checklist system. One embodiment of the system comprises a processor which controls the operation of the checklist system and memory connected to the processor. The memory stores alphanumeric data arranged in a set of predetermined checklists, each of which has a set of predetermined tasks and audio files associated with each predetermined task within each set of predetermined tasks. The system further comprises a display connected to the processor which displays the alphanumeric data stored in the memory. Other embodiments of the system further comprise input devices, such as, for example, soft programmable buttons (softkeys), hard programmed buttons (hardkeys), a rotary knob, etc., connected to the processor which enables an operator of the checklist system to scroll backward or forward though each set of predetermined tasks within each set of predetermined checklists and an audio output circuit connected to the processor which plays an audio file associated with a predetermined task within a set of predetermined tasks. Typically, the audio file is played when the associated predetermined task is displayed on the display means.

Such a checklist system delivers several advantages over the current state of the art. Soft programmable buttons with displayed labels on the display corresponding to each button, effectively present the context during checklist operation and provide improved functionality for a user. For example, when scanning through sub-lists, the soft keys display three navigation options for navigating into or through various sub-lists. However, when stepping through a checklist, the soft programmable button displays change to three different options to indicate the context of executing a checklist. The advantage is to reduce the mental effort required to operate the checklist by better indication of the context of the system function.

Another advantage of the present invention is the use of a single rotary knob that allows for complete forward or backward stepping or scrolling through a checklist or list of sub-list titles by having two functions of operation, preferably one function in rotation and another in a momentary push button. The advantages of this method of stepping through lists (in addition to just using buttons to navigate) include reduced movement of the hand and fingers to different locations on the checklist device, intuitive correspondence between degree of rotation of the knob and extent of movement through a list or other matter that can be represented with a linear or angular representation such as volume control, as well as having a protruding physical device for the user to grab onto during turbulent flight conditions when using a checklist in-flight.

Yet, another advantage of the invention is the use of additional navigational hardkeys. Compared to softkeys, hardkey buttons provide a more fixed and global input for navigation and audio/visual control functions. For example, a clearly marked (i.e. a distinguishing color such as red or white) button that requires only a single push to change the context of the display and list indexing to checklists for emergency or abnormal conditions.

Additionally, a menu button provides the function of moving the context of the system back or up one level in a hierarchy of lists or, if at the top level of a hierarchy, provides lateral navigation to different groups of lists or other functions of the user interface outside of a checklist mode.

Another aspect of the present invention is the ability to deliver aural messages simultaneous to visual information. This function gives more words than displayed messages which are limited by the number of characters per line of a display.

Yet, another aspect of the invention provides for receiving signals from other avionics systems such as a Controller/Pilot Data-Link Communications (CPDLC) subsystem which will cause an appropriate checklist to appear for some clearances. For example, a “cleared to land” CPDLC signal causes a BEFORE LANDING checklist to appear.

### BRIEF DESCRIPTION OF THE FIGURES

FIG. 1 shows a block diagram of suitable hardware for implementing various embodiments of the invention;

FIG. 2 shows an illustration of a user interface and panel arrangement for an embodiment of an improved aural/visual checklist processing system;

FIG. 3 shows an illustration of a user interface and panel arrangement when a checklist is selected for one embodiment of the invention;

FIG. 4 shows an illustration of all tasks within an exemplary checklist;

FIG. 5 shows an illustration of a user interface and panel arrangement when a checklist is completed for one embodiment of the invention;

FIG. 6 shows an illustration of a user interface and panel arrangement when a checklist is not completed for one embodiment of the invention;

FIGS. 7A and 7B show an illustration of a user interface and panel arrangement when audio panning is being configured; and

FIGS. 8A and 8B show an illustration of a user interface and panel arrangement when the Emergency/Abnormal button has been depressed.

### DETAILED DESCRIPTION OF THE PREFERRED EMBODIMENT

All terms used herein, including those specifically described below in this section, are used in accordance with their ordinary meanings unless the context or definition indicates otherwise. Also, unless indicated otherwise, except within the claims, the use of “or” includes “and” and vice-versa. Non-limiting terms are not to be construed as limiting unless expressly stated (for example, “comprising” means “including without limitation” unless expressly stated otherwise).

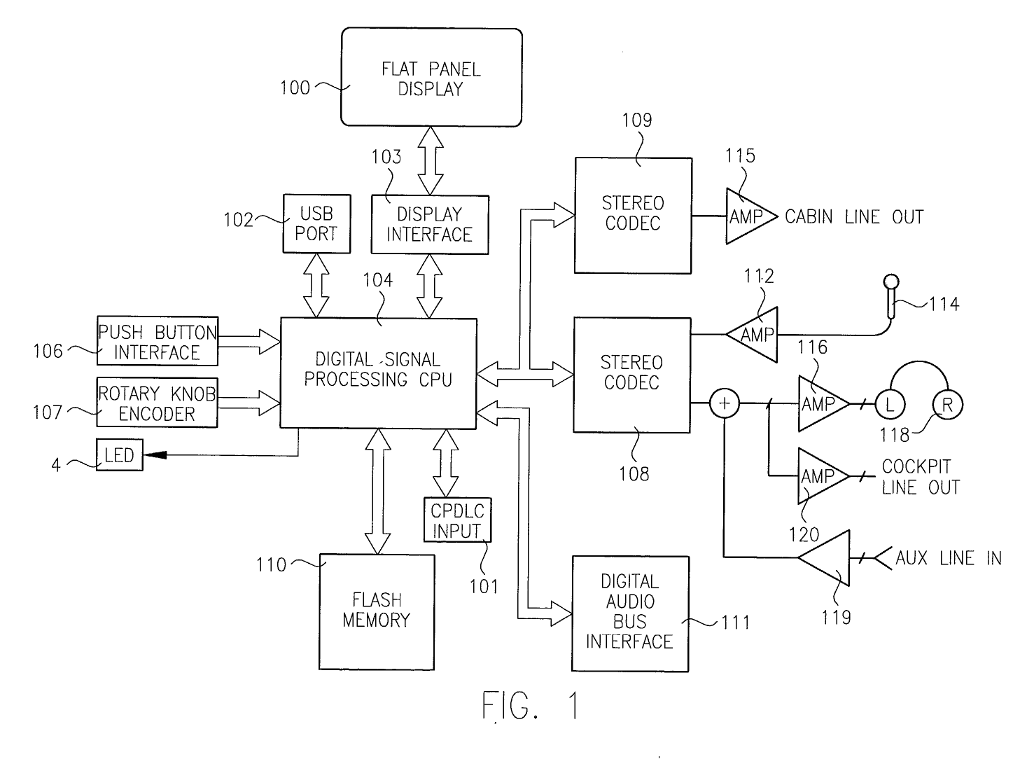

FIG. 1 shows a block diagram for suitable hardware for the improved aural/visual checklist processing system. This hardware includes a Digital Signal Processing Central Processing Unit (CPU) 104. The CPU 104 is connected to a Universal Serial Bus (USB) port 102. The USB interface 102 is suitable for rapid downloading of aural checklist messages from an external computer (not shown) with a common USB interface and cable.

Also connected to the CPU 104 is a flash memory device 110. Alphanumeric data representing sets of predetermined checklists is stored in the flash memory device 110. Each checklist contains a set of predetermined tasks that are required for various routines and procedures for aviation. Each task also has a related audio file which is also stored in the flash memory 110. Each audio file corresponding to each checklist task is typically stored in the flash memory 110 as a 16-bit linear sample of audio at a sample rate of nominally 16 KHz. A sample rate of 16 KHz provides approximately an 8 KHz audio bandwidth which is more than twice the typical bandwidth required in most aerospace communications applications. Alternatively, each audio file may be stored as a series of phoneme specifiers. The phoneme specifiers may be stored in a somewhat human readable form with a mnemonic set of letters to specify each phoneme or in a more compact form with merely a digital value for each. Then a dictionary of phoneme sounds, each sound associated with a specifier and stored as a short bit of audio data, is used to generate on the fly a set of digital audio data to be played.

The CPU 104 may be connected to several audio input and output devices. For example, one or more stereo Coder/Decoders (CODECs) 108, 109, are shown in FIG. 1 as connected to the CPU 104. Additionally, the environment may include a microphone preamp 112 connected to one or more microphones 114, a headphone amplifier 116 connected to one or more headphone sets 118, a stereo line-in amplifier 119, and a stereo line-out amplifier 120.

The microphone preamp 112 is provided so that voice audio data may be sampled by the system for use in a voice recognition algorithm used to perform hands-free voice commands. Voice commands derived from commercially available speech recognition algorithms running on the checklist system can be used to navigate through the checklist system by mapping voice commands to specific softkey and hardkey functions on the user interface.

A standard stereo headphone output amplifier 116 is provided to drive typical headphone sets as low as 32 ohms of impedance. Stereo lineout amplification 120 is provided to match the stereo output to suitable line levels for connecting the aural checklist system into auxiliary inputs of a cockpit audio system. A line-in amplifier 119 is provided so the improved aural/visual checklist processing system can be placed “in-line” with the cockpit audio final mixed output or suitably “patched” into any other auxiliary audio input and output ports in the cockpit audio system.

An additional stereo CODEC channel 109 and a lineout amplifier 115 are provided for sending passenger briefing audio independently from the mixed cockpit checklist audio. This output is connected to a typical audio power amplifier. A digital audio bus interface 111 is also provided that allows the system to digitally route input and output from audio channels allocated on a digital audio bus for all inputs and outputs to the cockpit and passenger cabin.

The suitable hardware includes user inputs and outputs (not all shown in FIG. 1) that are connected to the computer environment through interfaces. Exemplary interfaces include a push button interface 106, a rotary knob encoder 107, and an LED light 109. The push button interface 106 typically comprises a standard scanned set of mechanical contacts, and the rotary encoder interface 107 typically comprises a standard 2-bit digital quadrature interface. In one embodiment, a rotary knob is combined with a momentary push button feature that is scanned by the push button interface 106 along with other mechanical push buttons. Software debouncing of the mechanical switches is provided as is commonly practiced in designs of this nature by those individuals with common skills in digital microprocessor design. Also, a flat panel display 100 is connected to the CPU 104 through a flat panel display interface 103. The flat panel display 100, in one embodiment, is a vacuum florescent display suitable for aircraft instrumentation use due to its good visibility in bright sunlight conditions and wide operating temperature range.

Finally, the suitable hardware includes an input from and an output to a Controller/Pilot Data-Link Communications (CPDLC) device. When an input is received from a CPDLC device, a particular checklist will be implemented. Likewise, when a particular checklist or task has been completed, a CPDLC signal will be sent from the processor to the CPDLC device.

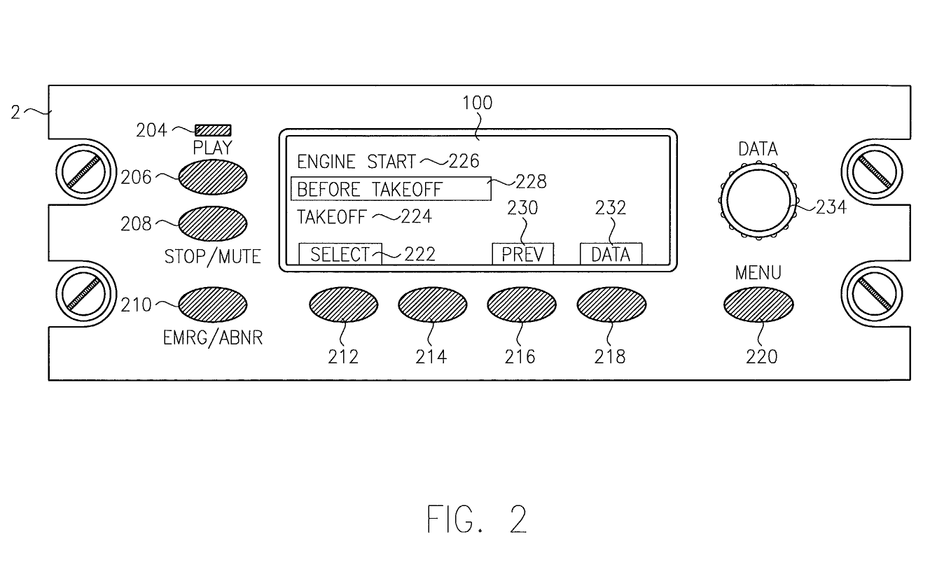

FIG. 2 shows a typical user interface and panel arrangement for the improved aural/visual checklist processing system. In this example, the flat panel display 100 is centered in the user interface arrangement. Several input devices are shown surrounding the flat panel display, and as previously mentioned, each input device is connected to the CPU 104 (FIG. 1) via an interface (i.e. push button interface 107). The various input devices shown in FIG. 2 include a PLAY button 206, a STOP/MUTE button 208, an EMERGENCY/ABNORMAL button 210, four programmable softkey buttons 212, 214, 216, and 218, a MENU button 220 and a rotary knob device 234. Finally, a light emitting diode (LED) indicator 204 is also shown in FIG. 2. Each of these input and output devices are described below.

The flat-panel display 100 shows alphanumeric data that is stored in the flash memory 110 (FIG. 1). A checklist hierarchy is provided that arranges specific tasks into checklists for presentation when appropriate input commands are entered. In this fashion, a user can navigate between different checklists and between different tasks within the checklist to highlight a particular item. ENGINE START 226 is an example checklist title of a particular checklist that contains all tasks related to an engine starting procedure. Similarly, BEFORE TAKEOFF 228 is another checklist for all tasks related to the procedures that need to be accomplished prior to aircraft takeoff. Finally, in FIG. 1, TAKEOFF 224 is yet another example checklist that contains all tasks related to a takeoff phase of flight.

A user of the improved aural/visual checklist processing system can scroll the display up and down to scan for more checklist titles by using the rotary knob 234. By rotating the rotary knob 234 in one direction, the list displayed on the display will scroll up, while rotating the rotary knob 234 in the opposite direction will scroll the displayed list down. Alternatively the programmable softkey buttons 212, 214, 216, and 218 can be programmed to accomplish list scrolling as well. In the embodiment shown in FIG. 1, the third softkey 216 has been programmed to scroll to the previous list item whereas the fourth softkey 218 has been programmed to scroll to the next list item. This is indicated in the display by a corresponding label. As shown, the third softkey 216 is labeled PREV 30 and the fourth softkey 218 is labeled NEXT 32.

Whenever a user scrolls through the list of checklist titles, an inverse video highlight, as shown surrounding the BEFORE TAKEOFF checklist title 228, is applied to the active line of the display. If either the first softkey button 212 (labeled SELECT 222) or the rotary knob 234 is pressed while an item is highlighted, the display will change to the corresponding checklist of tasks or a sub-list of further checklists. As the user navigates through checklists and sub-list titles, a corresponding aural announcement is played through an audio output circuit. Recall, that each checklist, sub-list or task not only has alphanumeric data stored in the flash memory, but also an audio file corresponding to each checklist, sub-list or task. Thus, as a user scrolls through the items in a display, not only is each item highlighted, but also each item's corresponding audio file is played through the audio output circuit.

Additionally, the PLAY button 206, when depressed, causes the audio file corresponding to the highlighted line item on the display to be played through the audio output circuit. Also, the audio status LED 204 will blink while any audio file is playing. Pressing the STOP/MUTE 208 button will terminate a currently playing audio file. All audio will be muted (i.e. prevented from playing through the audio output circuit) if pressed while no audio files are playing. Typically, the audio status LED 204 will remain on if checklist audio is not muted, off if it is muted, or blink while an audio file is playing.

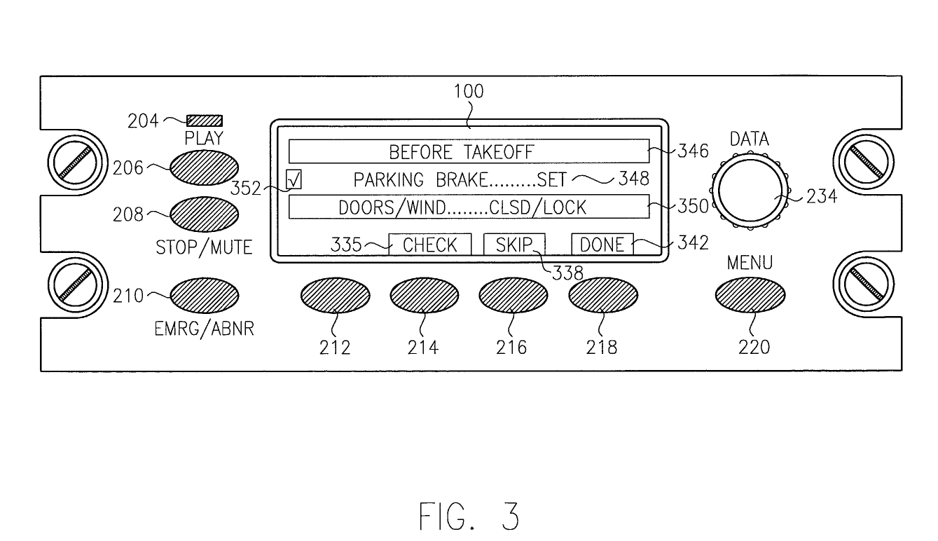

FIG. 3 shows the user interface and panel arrangement presented as a result of selecting a highlighted item (BEFORE TAKEOFF 228, shown in FIG. 2) by either pressing the first softkey button 212 or pressing in the rotary knob 234. In this case, the title of the checklist, BEFORE TAKEOFF 228, is displayed on the top line of the display in inverse video 346. Each programmable softkey 212, 214, 216, and 218 now has a different function associated with it. The checklist functionality of each softkey is labeled on the display. The second softkey 214 is a CHECK 335 function; the third softkey 216 is a SKIP 338 function; and the fourth softkey 218 is a DONE 342 function. A checklist complete checkbox 352 is provided to indicate with a check mark which items on a checklist have been completed. All checkbox items are reset when entering or reentering the checklist.

All checklist items are programmed according to the standard checklist protocol of a “challenge” and a “response.” For example, in the first displayed checklist item 348, the challenge is “Parking Brake” and the response is “SET”. As soon as the second softkey button 214, labeled CHECK 335 is pressed, the inverse video highlight advances to the next checklist challenge and response item on the list, i.e. [Door/Wind . . . CLSD/LOCK] 350.

If the third softkey button 216 with the label SKIP 338 is pressed, the highlighted item is not checked off and is moved to the top of the scrollable area and the inverse video highlight is moved to the next challenge and response item. If, for some reason, it is desired to skip checklist items until later, for example [Door/Wind . . . CLSD.LOCK] 350, the task will not be check marked and will be left over as unchecked items after the rest of the list is checked off.

If the fourth softkey button 318 labeled DONE 342 is depressed at anytime, regardless of checklist items that have not been marked as completed, the screen display of FIG. 6 (described below) is presented. Also, if the MENU button 220 is depressed at any time, the screen display of FIG. 6 (described below) is presented.

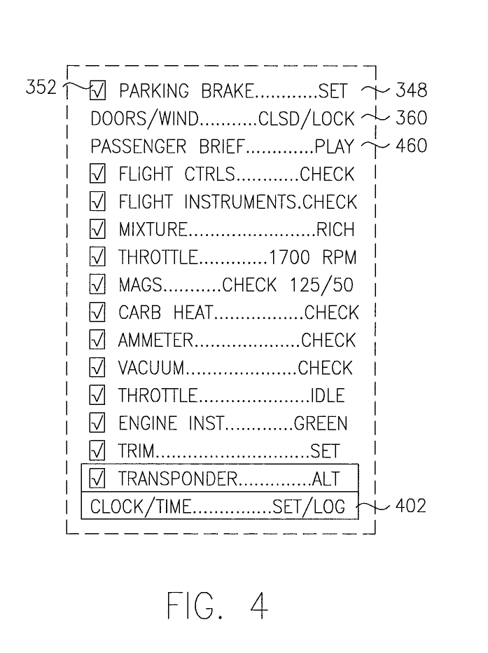

FIG. 4 shows an entire list of one particular checklist, in this example, the BEFORE TAKEOFF 228 checklist. As can be seen, there are two skipped tasks; [(Door/Wind . . . CLSD.LOCK] 350 and [PASSENGER BRIEF] 460) as indicated by a lack of a checkbox 352. This is not a displayable list, but rather an illustration of how the checklist items are logically arranged in the memory 110.

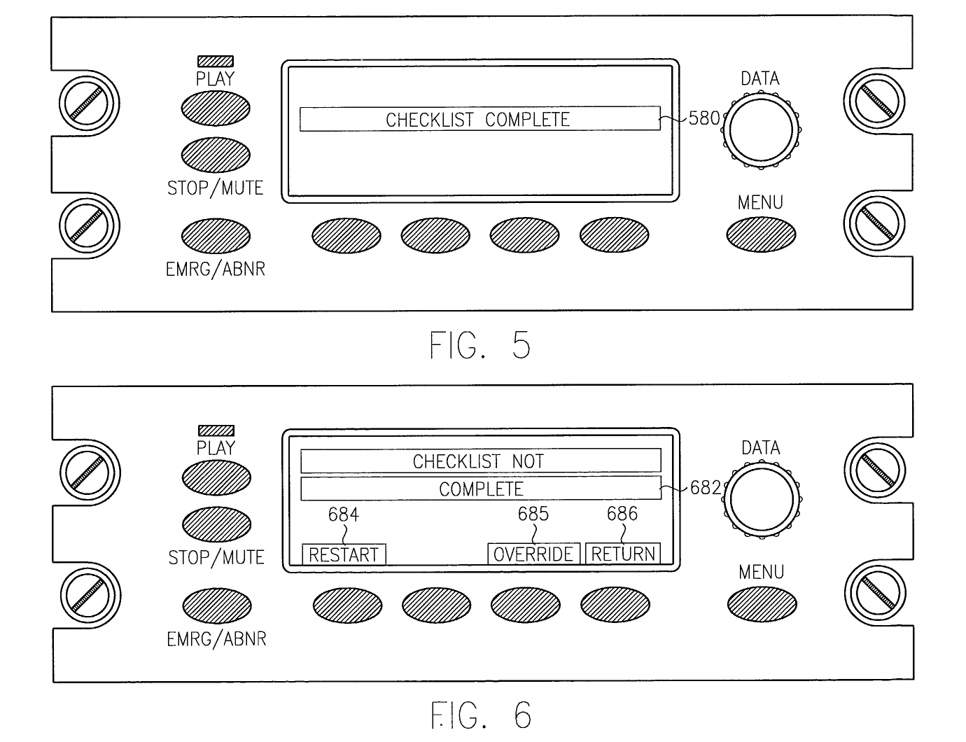

The following discussion illustrates, by example, the sequence of events that occur when an item is skipped and a checklist is near completion. Using the example of FIG. 4, the second and third checklist tasks, [Door/Wind . . . CLSD.LOCK] 350 and [PASSENGER BRIEF] 460, have not been checked off and the final task, [Clock/Time . . . SET/LOG] 462, is highlighted pending checkoff. One of three possible softkey buttons can be depressed at this point, CHECK 335, SKIP 338, and DONE 342. If all prior items had been checked off at this position at the bottom of the checklist and softkey button corresponding to CHECK 335 were pressed one more time, then the screen display of FIG. 5 would appear momentarily with the line, CHECKLIST COMPLETE 580. Additionally, an audio file announcement that all items have been successfully completed would be played through the audio output circuit. If instead, the softkey button corresponding to SKIP 338 is pressed at this point, then the screen display of FIG. 6 is displayed; CHECKLIST NOT COMPLETE 682. Additionally, the audio file, “checklist not complete” is announced via the audio output circuit.

At this point, the user is given three choices with the softkey buttons. The softkey button choices are labeled with RESTART 684, OVERRIDE 685, or RETURN 686. If the user presses RESTART 684, then each task on the checklist is reset and the checklist sequence will start again. If the user presses the OVERRIDE 685, button, then the checklist sequence will terminate as if all checklist tasks have been completed, and the display of FIG. 5 will be displayed momentarily before the display will return to the master checklist. Finally, if the user presses the button labeled RETURN 686 then the display returns to the first skipped items at the top of the list (i.e. [Door/Wind . . . CLSD.LOCK] 350 and [PASSENGER BRIEF] 460 as shown in FIG. 4).

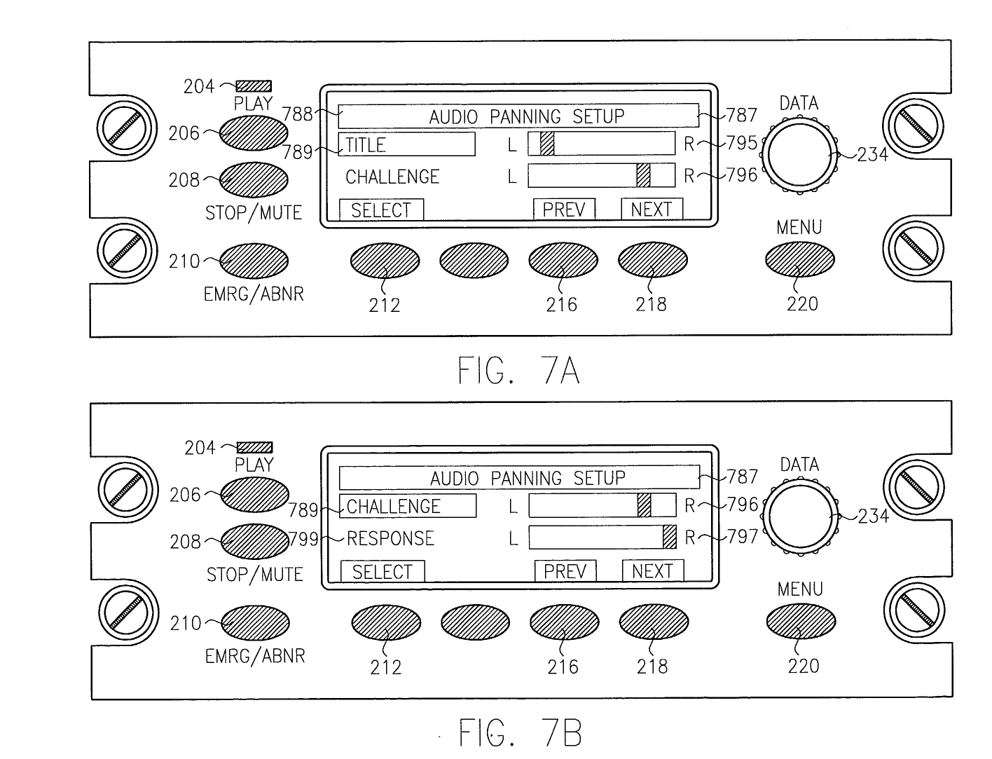

Another feature of the improved aural/visual checklist processing system is the ability to pan audio output to different channels. FIGS. 7A and 7B show the stereo panning setup for controlling the left/right audio panning of the Item Title output 788, Checklist Challenge output 789 and Checklist Response output 799. When a SELECT function is entered (softkey button 212 or rotary knob 234 is pressed), the inverse video highlight will blink to indicate the parameter that is now active. Using the rotary knob 234 or the softkey buttons (PREV 216 or NEXT 218), the cursor in the bar graph slider window for Item Title 795 will move left or right according to how much panning the user desires for that parameter output. By a similar process, the cursor in the bar graph slider window for Checklist Challenge 796 or Checklist Response 797 can be moved left or right. When a SELECT function is pressed again, the blinking ceases and the softkey button corresponding to PREV 216, NEXT 218 and rotary knob 234 revert back to moving the inverse highlight cursor up and down between the three selections on the list.

Another feature of the improved aural/visual checklist processing system is an EMERGENCY/ABNORMAL button 210. Pressing this EMRG/ABNR button once changes the context to the emergency checklists and pressing it a second time swaps the context to the abnormal checklists. After executing an emergency checklist the context either changes to a different checklist that is appropriate to be processed next or, after all sub-list “chains” (explained below) have been processed, the display then returns to the point in the normal checklist or other functionality of the device that was interrupted.

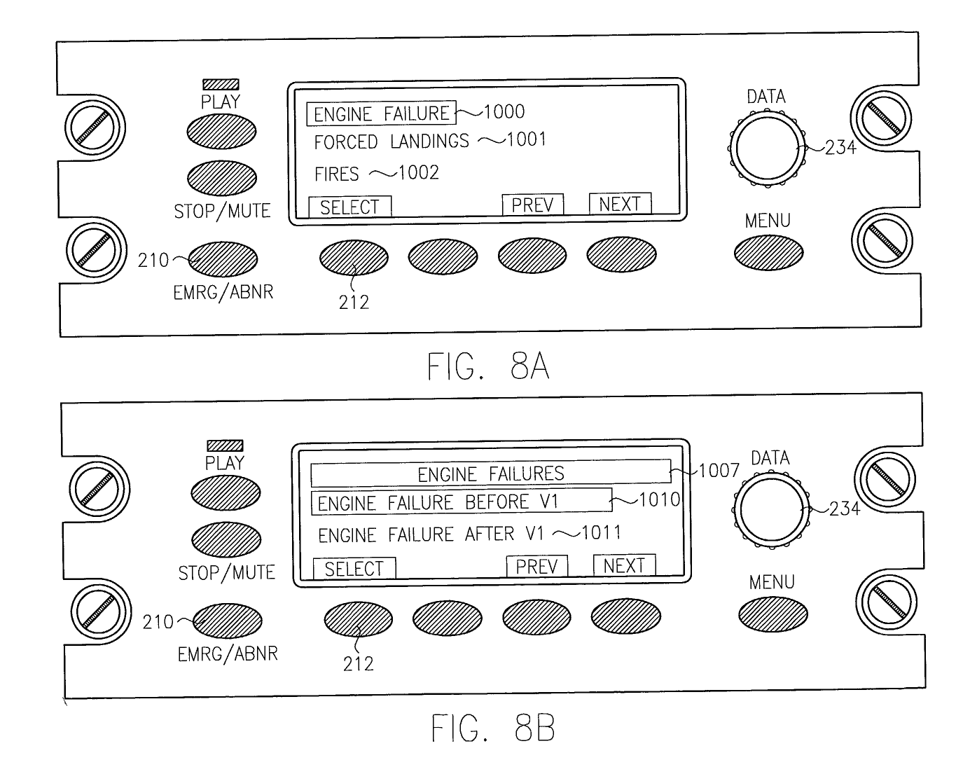

FIG. 8A shows the immediate resulting display as a result of pressing the EMRG/ABNR button 210. Upon depressing this button, any current operation is suspended and control immediately switches over to an emergency/abnormal checklist set. FIG. 8A shows an example display of the first three checklist titles of the emergency checklists: ENGINE FAILURES 1000, highlighted in inverse video, FORCED LANDINGS 1001 and FIRES 1002. If a SELECT (softkey 212 or rotary knob 234) is pressed while ENGINE FAILURES 1000 is highlighted, the display transitions to the display of FIG. 8B.

FIG. 8B shows the first two sub-lists (ENGINE FAILURE BEFORE V1 1010, and ENGINE FAILURE AFTER V1 1011) under the ENGINE FAILURES checklist heading 1007. If ENGINE FAILURE BEFORE V1 1010 is SELECTED, then this checklist is executed like any other checklist as described above. Likewise, if ENGINE FAILURE AFTER V1 1011 is SELECTED, then this checklist is executed like any other checklist. Other control features, such as, for example, the MENU button 220, function as described above with any other checklist.

While embodiments of the invention have been illustrated and described, it will be appreciated that various changes can be made therein without departing from the spirit and scope of the invention.

The embodiments of the invention in which an exclusive property or privilege is claimed are defined as follows:

1. A checklist system with a dual function rotary knob comprising:
a a processor which controls operation of the checklist system;
b a memory connected to the processor which stores checklist alphanumeric data comprising a checklist having a set of tasks;
c a display connected to the memory which displays the alphanumeric data stored in the memory; and
d a rotary knob electrically connected to the processor capable of rotation in one direction and an opposite direction, the knob causing the display to scroll forward through the tasks in the sets of tasks when rotated the one direction and that causes the display to scroll backward through the tasks in the sets of tasks when turned in the opposite direction.

2. The checklist system of claim 1 wherein the rotary knob also has a push button function by which a pressing of the knob causes an action with respect to a displayed task.

3. The checklist system of claim 1, wherein the display displays more than one line of alphanumeric data.

4. The checklist system of claim 1 further comprising an audio output circuit connected to the processor which plays an audio file associated with a task, the audio file playing when the associated task is displayed.

5. The checklist system of claim 4, further comprising a second input device enabling an operator of the checklist system to stop playing of the audio file when the associated task is displayed.

6. The checklist system of claim 4, wherein the audio output circuit further comprises a first channel and a second channel.

7. The checklist system of claim 6, wherein the audio output circuit further comprises a control device for panning an audio output to the first channel or the second channel.

8. The checklist system of claim 1, further comprising a second input device connected to the processor which receives a Controller-Pilot Data Link Communications (CPDLC) signal from a CPDLC device.

9. The checklist system of claim 1, further comprising an output device connected to the processor which sends a Controller-Pilot Data Link Communications (CPDLC) signal to a CPDLC device.

10. A checklist system with a user input device for switching to a special checklist, comprising:
a a processor which controls operation of the checklist system;
b a memory connected to the processor which stores checklist alphanumeric data comprising a set of checklists, each checklist having a set of tasks, one of the checklists being a special checklist;
c a display connected to the memory which displays the alphanumeric data stored in the memory;
d a user input device electrically connected to the processor which, when activated, causes the display to switch to the special checklist, the user input device having no other function; and,
e an indelible label associated with the user input device, the label indicating the special character of the checklist.

11. The checklist system of claim 10, wherein the user input device is a hardkey.

12. The checklist system of claim 10, wherein the special checklist is an emergency checklist.

13. The checklist system of claim 10, wherein the special checklist is an abnormal condition checklist.

14. The checklist system of claim 10, wherein each activation of the user input device causes the display to cycle among an emergency checklist, an abnormal condition checklist, and a status that the system was in before the user input device was pressed.

15. A checklist system with a CPDLC link comprising:
a a processor which controls operation of the checklist system;
b a memory connected to the processor which stores alphanumeric data comprising a checklist having a set of tasks;
c a display connected to the memory which displays the alphanumeric data stored in the memory;
d an first user input device connected to the processor; and
e a second input connected to the processor which receives a Controller-Pilot Data Link Communications (CPDLC) signal from a CPDLC device, thereby causing an action by the checklist system.

16. The checklist system of claim 15, wherein the action is to cause the display to display a particular task.

17. The checklist system of claim 15, wherein the checklist is one of a plurality of checklists and the action is to cause the display to display a particular checklist of the plurality of checklists.

18. The checklist system of claim 15, wherein the display displays more than one line of alphanumeric data.

19. The checklist system of claim 15, further comprising an audio output circuit connected to the processor for playing an audio file stored in the memory and a CPDLC message causes playing of the audio file.

20. The checklist system of claim 19, wherein the audio output circuit further comprises a first channel and a second channel and a control device for panning the audio output to the first channel or the second channel.

21. The checklist system of claim 15, wherein the first input device is an aural input device that activates a speech recognition program running on the processor.

22. The checklist system of claim 15, wherein the first input device is a rotary knob which rotates in one direction and an opposite direction, the rotation causing the display to scroll forward through the tasks in the sets of tasks when rotated the one direction and to scroll backward through the tasks in the sets of tasks when turned in the opposite direction.

23. A checklist system with a dual function, dual labeled input comprising:
a a processor which controls operation of the checklist system;
b a memory connected to the processor which stores alphanumeric data comprising a set of checklists, each checklist having a set of tasks;
c a display connected to the memory which displays the alphanumeric data stored in the memory;
d a first dual function input device having a first function and a second function where a first associated label is illuminated and indicates the first function when no checklist is selected and, when a checklist is selected, a second label is illuminated and indicates the second function.

24. The checklist system of claim 23 further comprising:
a a second dual function input device having a first function and a second function where a first associated label is illuminated and indicates the first function when no checklist is selected and, when a checklist is selected, a second label is illuminated and indicates the second function.

25. The checklist system of claim 24 further comprising:
a a third dual function input device having a first function and a second function where a first associated label is illuminated and indicates the first function when no checklist is selected and, when a checklist is selected, a second label is illuminated and indicates the second function.

26. The checklist system of claim 23 wherein the first input device is a push button.

27. The checklist system of claim 23 wherein the first input device is an aural input device that activates a voice activated program running on the processor.

28. The checklist system of claim 23, wherein the display displays more than one line of alphanumeric data.

29. The checklist system of claim 24, wherein the first and second input devices are each pushbuttons.

30. The checklist system of claim 23, further comprising an audio output circuit connected to the processor which plays an audio file stored in the memory, the output circuit having a first channel and a second channel and the first and second input devices allow panning between the first channel and the second channel.

31. The checklist system of claim 23, wherein activation of the first input device causes the processor to send a Controller-Pilot Data Link Communications (CPDLC) signal to a CPDLC device.

32. A checklist system that requires confirmation to exit a checklist, comprising:
a a processor which controls operation of the checklist system;
b a memory connected to the processor which stores checklist alphanumeric data comprising a checklist having a set of tasks;
c a display connected to the memory which displays the alphanumeric data stored in the memory; and
d at least one user input device electrically connected to the processor by which a user may indicate to the system that, having activated a checklist, the user wishes to exit the checklist; and
e the processor being programmed such that, once the user input device is activated while a checklist is active, the display presents a message requesting confirmation and the system will not exit the checklist unless additional user input is provided indicating confirmation.

33. The checklist system of claim 32 wherein the user input device is a push button.

34. The checklist system of claim 32 wherein the user input device is an aural input device that activates a program running on the processor.

35. The checklist system of claim 32, wherein the user input device is a rotary knob which rotates in one direction and an opposite direction, the rotation causing the display to scroll forward through the tasks in the sets of tasks when rotated the one direction and that causes the display to scroll backward through the tasks in the sets of tasks when turned in the opposite direction.

36. The checklist system of claim 32, wherein the display displays more than one line of alphanumeric data.
